(19) United States
(12) Patent Application Publication
(10) Pub. No.: US 2007/0088621 A1
(43) Pub. Date: Apr. 19, 2007

(54) Online purchasing method

(76) Inventors: George B. Hamilton IV, Laredo, TX (US); Rankin A. Clinton III, Franklin, TN (US)

Correspondence Address: STITES & HARBISON PLLC, 424 CHURCH STREET, SUITE 1800, NASHVILLE, TN, 37219-2376, US

(21) Appl. No.: 11/507,022

(22) Filed: Aug. 21, 2006

Related U.S. Application Data
(60) Provisional application No. 60/709,970, filed on Aug. 19, 2005.

(51) Int. Cl. G06Q 30/00

(52) U.S. Cl. 705/26

(57) ABSTRACT

A method of managing multiple, simultaneous, multi-parameter negotiations for and purchase of products or services in an online private contract environment. Embodiments of this method may comprise: a process to compile a database consisting of value-relevant product attributes and buyer demand attributes; a protocol to search, sort and display products and demand for products based upon these attributes; a protocol to aggregate products into “pooled” lots for sale; a protocol to allow sellers to negotiate simultaneously with multiple potential buyers on a private contract basis; a protocol to allow sellers to retain partial ownership in the products; a protocol to produce a financial reconciliation upon delivery of the products or services.

### CROSS-REFERENCE TO RELATED APPLICATIONS

This application claims the benefit of provisional patent application No. 60/709,970, filed Aug. 19, 2005, herein incorporated in its entirety by reference.

### FIELD OF INVENTION

This invention relates generally to the field of online purchasing. More specifically, aspects of the present invention relate to purchasing products and services online in a simultaneous, multi-party, private contract format.

### BACKGROUND OF THE INVENTION

Online platforms for the trading of goods and services are becoming increasingly popular. These platforms may take the form of auctions, reverse auctions, and catalog sales. In auctions and reverse auctions, the winner is designated as that party who has bid the highest (or lowest in the case of reverse auctions) when the time for the auction has concluded. In catalog sales, the buyer purchases at the published price. In a private contract sale, the buyer and seller have the ability to negotiate with whomever they choose, set the terms and conditions of the transaction, and conclude a transaction when there is agreement on these terms and conditions. However, these private parties are typically negotiating without knowledge of their competitive options.

### SUMMARY OF THE INVENTION

The present invention is directed to enabling buyers and sellers to conduct simultaneous, one-on-one negotiations for the sale or purchase of products/services in a market informed context.

One aspect of the present invention concerns improvements related to selling and buying products and services in an online environment. It relates particularly, although not exclusively, to the provision of an online product/service sale platform whereby sellers and buyers are allowed to manage multiple, simultaneous, multi-parameter negotiations for the purchase or sale of the product/service on a private contract basis.

### BRIEF DESCRIPTION OF THE DRAWINGS

FIG. 1 is a flow chart depicting a login protocol of the present system based on role and activity, in accordance with the present invention;

FIG. 2 is a flow diagram depicting the creation, modification, deletion and use of Pre-Sale Profiles, in accordance with the present invention;

FIG. 3 is a flow chart depicting the creation of a pooled pre-sale profile, in accordance with the present invention;

FIG. 4 is a flow chart showing the activities associated with lots and orders, in accordance with the present invention;

FIG. 5 is a flow chart showing rules regarding orders, in accordance with the present invention;

FIG. 6 is a flow chart showing offer sequences between a buyer and producer, in accordance with the present invention;

FIGS. 7A and 7B are parts one and two, respectively, of a single flow chart depicting bid management status for the offer sequence, in accordance with the present invention; and

FIG. 8 is a flow chart depicting the basic interaction between Logistics, the Agent, Accounting and Customer Service in the completion of a sale, in accordance with the present invention.

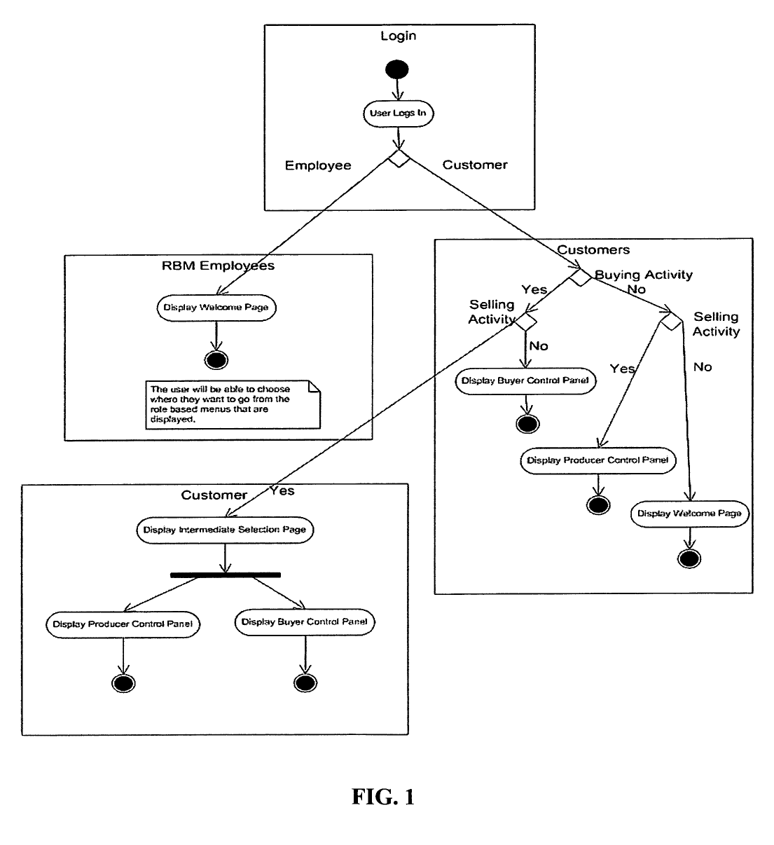

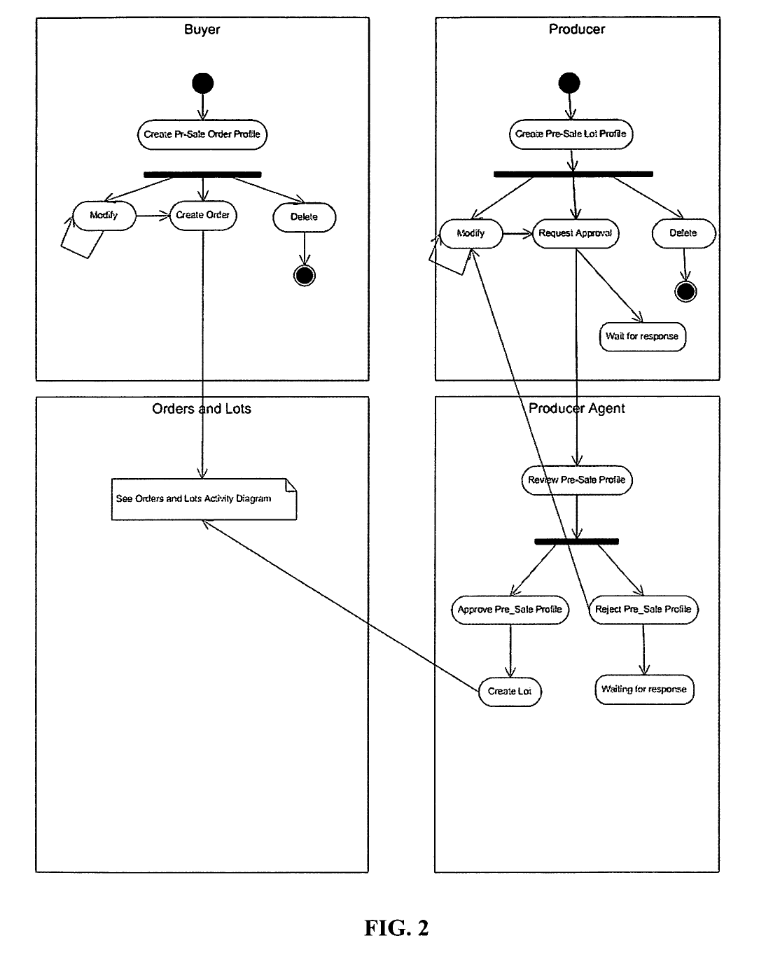

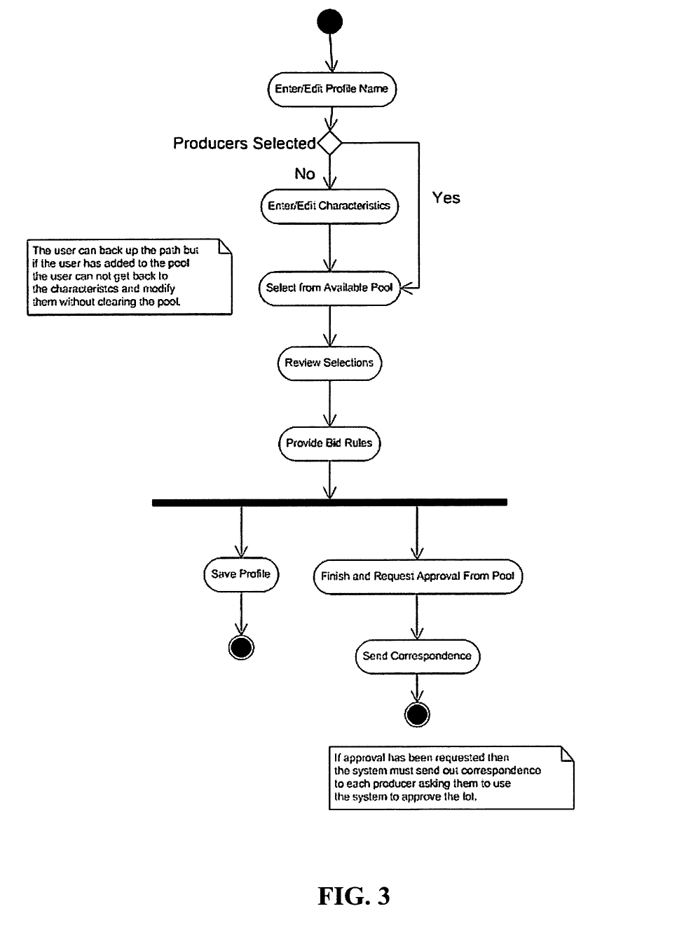

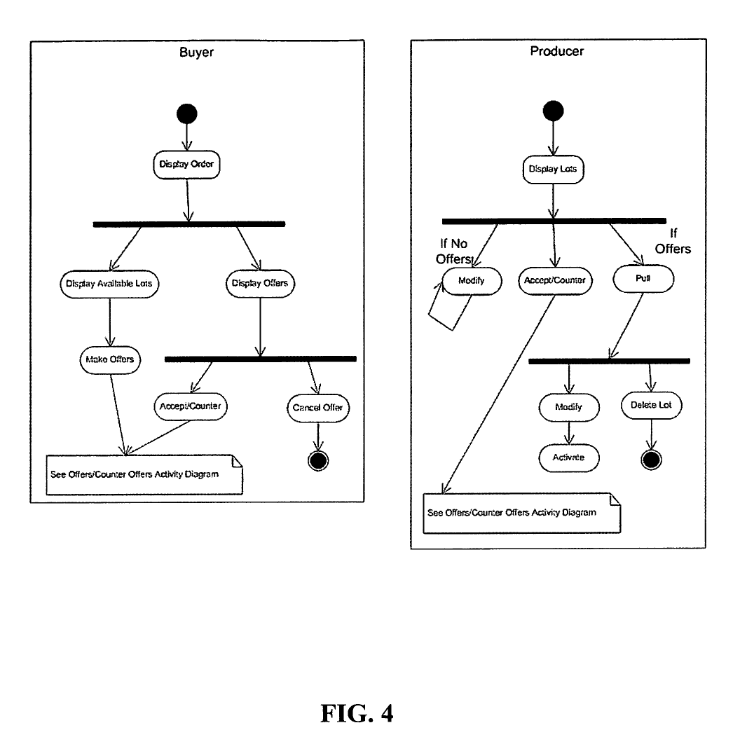

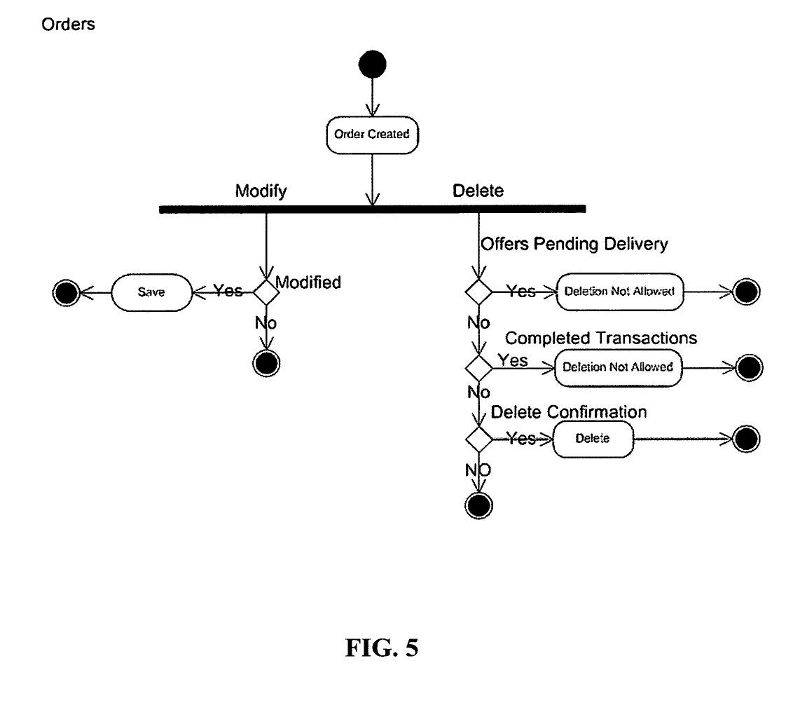

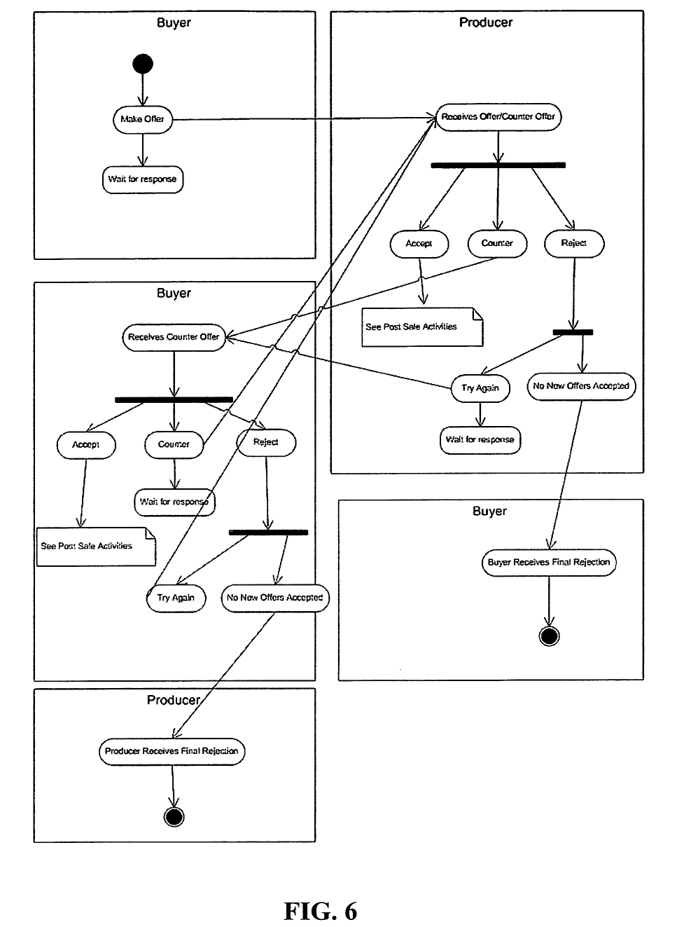

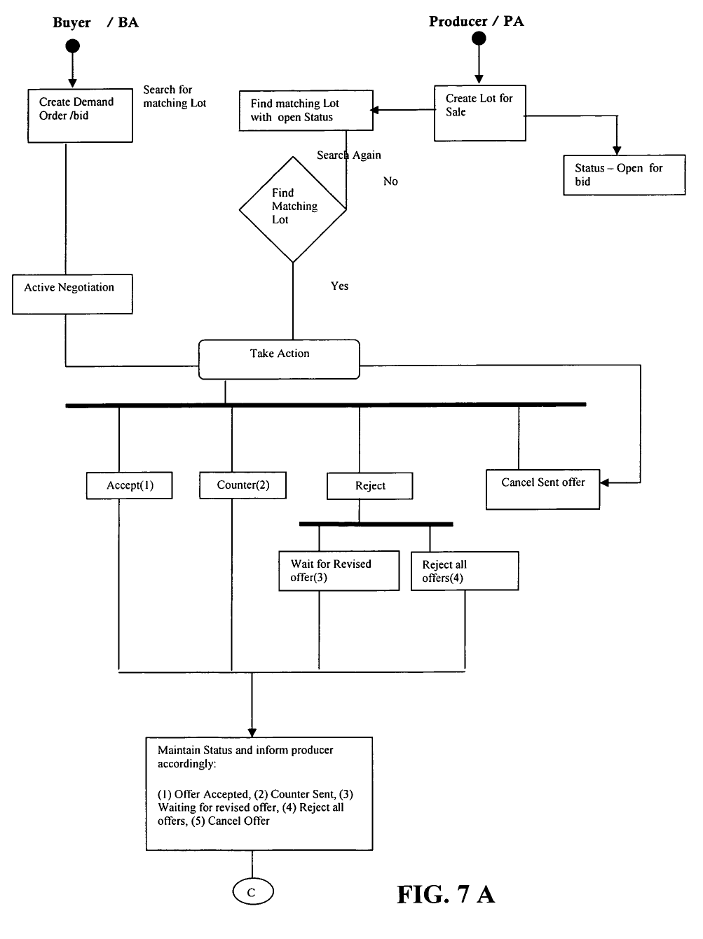

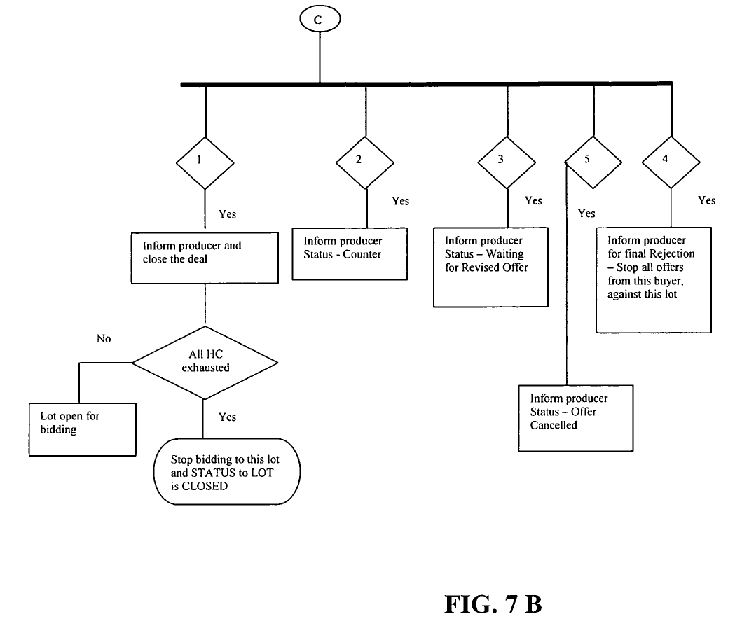

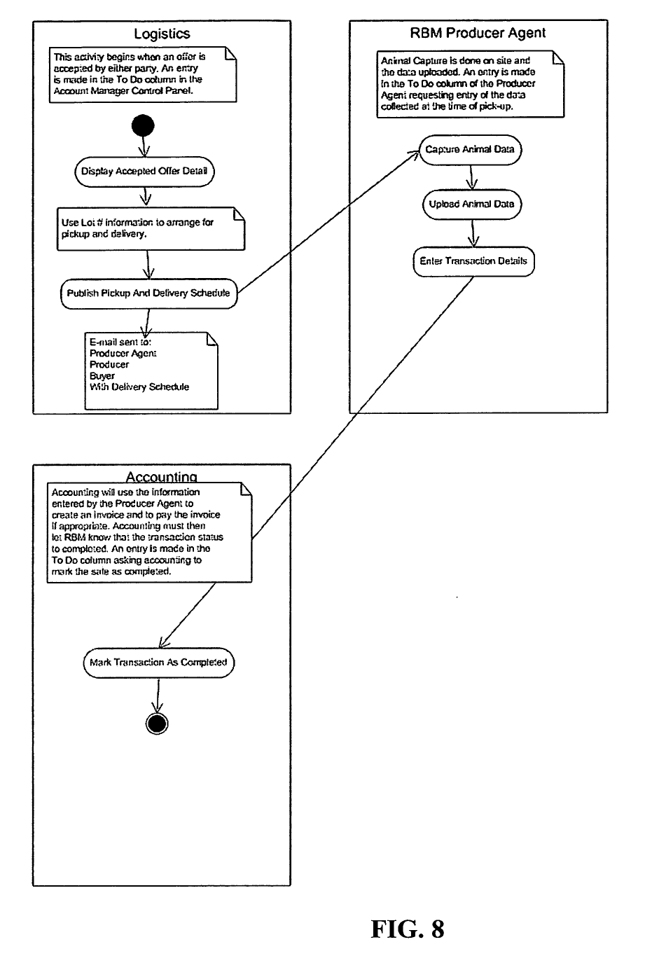

### DESCRIPTION OF THE INVENTION

As indicated above, aspects of the present invention include a comprehensive online transaction management environment. In embodiments of the present invention, buyers and sellers can register and be approved by the Host, according to prevailing credit policies for example.

Once approved, the parties can be granted log-in privileges. Upon log-in, the party can be directed to their unique home page where they are given access to their transaction Control Panel and other tools. The Transaction Control Panel can be their “dashboard,” which can enable various functions, including, for example, enabling the user search for products or demand for products, view summary and detailed information regarding their pending negotiations, enter offers/counteroffers on transactions, and view the history of closed transactions. Actions by other users calling for a response (counteroffer, rejection, or acceptance) from the user can be prominently displayed to enable the user to manage its negotiations.

Product Attributes: The seller can characterize its product/service relative to value-relevant attributes. The buyer likewise can characterize its requirements according to these attributes. These characterizations can be compiled by the invention into Lot Profiles and Order Profiles respectively. The Lot Profile can be a product “listing” describing the product and the terms upon which it is being offered for sale.

Searching for Products or Buyers: In embodiments of the present invention, Sellers may search the database of Order Profiles to ascertain the “demand” for their product/service and view results ranked upon the extent to which the demand corresponds to the specific attributes of the seller's product. Likewise, the buyer may search Lot Profiles to ascertain the “availability” of products that meet their requirements ranked upon the extent to which the available Lots correspond to the Order Profile. Sellers and buyers may thereafter elect to enter simultaneous negotiations with an unlimited number of parties to sell or buy the product.

The present invention also can provide a transaction management toolset to enable the transaction intermediary, or Host, to provide value-added involvement of agents to assist the parties in the process or permit the buyers and sellers to interact directly through the online environment without the aid of agents.

Pooling: Embodiments of the present invention provide for aggregation of like-in-kind products into lots comprising a full “load” for purposes of realizing economies of transportation and distribution and to provide a means for small producers to participate in larger markets.

Negotiation, Retained Ownership: Embodiments of the present invention also enable the seller and buyer to negotiate based upon price and retained ownership. In such a retained ownership transaction, the seller can retain an undivided interest in the sold products as a means to hedge his price position. Thus, a seller can accept a lower price with a higher retained ownership if he believes the price of the product is likely to go up in the near term.

Embodiments of the present invention allow sellers to “put” an offer to a buyer, as well as enabling buyers to make on offer to a seller. These embodiments allow the offeror to express their offer in terms of price and retained ownership. Once entered, the offer posts to the other party's Control Panel and that party is alerted by email of the pending offer. Offers may be made to expire at specified dates and times, or will expire, if not accepted, when the listing for the product expires. In embodiments, buyers and sellers may negotiate simultaneously with any number of parties. Offers not expressly accepted are deemed rejected.

Contract Formation: The invention negotiation process can continue until an offer/counteroffer is “accepted” by a party, at which time a contract is formed.

Final Reconciliation: The invention can provide a method to coordinate product delivery, reconcile the “listed” products to the “delivered” products, and produce a financial statement including computed fees, commissions and expenses of the Host/intermediary.

Value Tracking: The invention can capture transaction specific data regarding the attributes of the sold products and the price at which they sold. This data, on an historical basis, enables the Host and users to adapt their product and procurement strategies to how the market is valuing the attributes of the products.

In the preset online system, and an Account Manager is responsible for all of the back-office activities required to support the Field Agent. The Account Manager will have all of the functionality of the Field Agent. Buyers are individuals or corporations that purchase beef. A buyer has an account. The Buyer and the Buyer's Account will be setup in the Enhanced Private Treaty (EPT) by the Field Agent and the systems virtual actor. The EPT can take action based on interactions with other systems Actors and with Scheduled Events.

A Field Agent provides a primary point of contact for the Reputation Beef Management (RBM) constituent base: Sellers, Buyers, Lot, Animal, Shipper, Sponsors, and Broker. The Field Agent recruits, acquires information, manages the information and provides feedback and analytics to RBM constituents.

The Buyer will be qualified by the Account manager. The Account Manager will notify the Buyer that the Buyer is Qualified to trade. The Buyer will interact with the EPT via legal methods. The Buyer will be provided access to Service Agents. Buyers will interact with EPT through the Field Agent, Proxy, Service Agent, Broker, Inspector and EPT.

A Service Agent offers live telephone based service for the Seller and Buyer. The Service Agent accepts inbound call from the Buyer and Seller. The Service Agent escalates issues to the Field Agent.

The Seller is an individual, a corporation, a feedlot, a hobbyist. The Seller acts as a Producer-Seller or as a Pure-Seller. The EPT will not distinguish types of Sellers; instead the EPT will track Lot/Animal by Producer. For this reasons the EPT will treat Producer-Sellers as a data element and not as an active Agent.

The Sponsor provides marketing opportunities for the EPT. The EPT will provide context sensitive advertising and product positioning opportunities for the Sponsor.

In the invention thus being described herein, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. Particularly, it should be obvious that specific screenshots, steps, etc. can be modified without departing from the spirit of the present invention.

What is claimed:

1. A method for managing multiple, simultaneous, multi-parameter negotiations for and purchase of products or services in an online private contract environment, the method comprising:
compiling a database consisting of value-relevant product attributes and buyer demand attributes;
providing a protocol for searching, sorting, and displaying products and demand for products based upon these attributes;
providing a protocol to aggregate products into “pooled” lots for sale; and
allowing sellers to negotiate simultaneously with multiple potential buyers on a private contract basis.

2. The method of claim 1, further comprising allowing sellers to retain partial ownership in the products.

3. The method of claim 2, further comprising producing a financial reconciliation upon delivery of the products after sale.

4. The method of claim 1, further comprising producing a financial reconciliation upon delivery of the products after sale.
